(19) United States
(12) Patent Application Publication
(10) Pub. No.: US 2009/0077493 A1
(43) Pub. Date: Mar. 19, 2009

(54) Method for the Selection of Functions with the Aid of a User Interface, and User Interface

(75) Inventors: Thomas Hempel, Erlangen (DE); Roman Vilimek, Munchen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/282,362

(22) PCT Filed: Feb. 22, 2007
(86) PCT No.: PCT/EP07/51729

§ 371 Date: Sep. 10, 2008

(30) Foreign Application Priority Data
Mar. 10, 2006 (DE) 102006011288.1

(51) Int. Cl. G06F 3/048

(52) U.S. Cl. 715/810

(57) ABSTRACT

The invention relates to a method in which the output of a multimode user interface is optimized according to the currently used input procedure or the currently used input device, thus allowing pictograms to be displayed on a screen during manual input, for example, said pictograms then being replaced by texts visualizing spoken commands when switching to voice input. The output is thus kept as concise as possible and as detailed as necessary at any time, resulting in increased comfort for the user. The multimode user interface is suitable for vehicle cockpits, personal computers, and all types of mobile terminals.

The invention relates to a method for the selection of functions with the aid of a user interface. Multimodal user interfaces allow inputs to a technical system with the aid of different input devices or input modalities. The technical system may be, for instance, the on-board computer of a vehicle, a personal computer, an aircraft or a production system. Furthermore, mobile terminals such as PDAs, mobile phones or games consoles also have multimodal user interfaces. Among the input modalities, a distinction can be made, for instance, between manual input, voice input and input by means of gestures, head or eye movements. Keyboards, switches, touch-sensitive screens (touchscreens), mice, graphics tablets, microphones for voice input, eye trackers and the like are suitable, for instance, in practice as input devices.

One example of a multimodal user interface is an interface which allows both voice input and manual input. The user's input is thus effected using two different input modalities and, associated with this, also different input devices. For its part, the user interface outputs information to the user. This may be effected, for its part, using different output modalities (visual output, acoustic output, haptic feedback, etc.). The user uses his inputs to select functions of the respective technical system which are also carried out immediately, if necessary. The output provides the user with feedback regarding his selection options or the selection made by him. When designing user interfaces, the requirements of the users and the technologies used must be taken into account. For example, for manual input devices, it is desirable from the point of view of the user to avoid a screen being overloaded with text by using pictograms to represent the functions which can be selected. This procedure is known, for instance, from graphical operator interfaces of personal computers. However, as part of voice input, it results in great variations in the vocabulary used among the individual users: on account of the pictograms, the user does not know which terms he can use as a voice command since a plurality of terms or synonyms are possible. However, modern voice recognition systems require the smallest possible number of different terms for a high recognition rate of voice inputs. For this reason, modern user interfaces which provide voice input for the selection of functions are configured in accordance with the “say-what-you-see” principle. The selection of valid voice commands is displayed on a screen in the form of text. This quickly results in text overload which is undesirable in the case of manual input.

The object is therefore to specify a method for the selection of functions with the aid of a user interface and to specify a user interface which facilitates interaction between a user and the user interface.

This object is achieved by means of the method for the selection of functions with the aid of a user interface and the user interface as well as the vehicle cockpit and the computer program according to the independent claims. Developments of the inventions are defined in the dependent claims.

In the method for the selection of functions with the aid of a user interface, a user selects functions of a technical system with the aid of the user interface. Information represents the functions and/or confirms their selection. The information is output in a first output mode in a first form which is optimized for a first input modality or a first input device. Furthermore, the information is output in a second output mode in a second form which is optimized for a second input modality or a second input device.

The method affords the advantage that the first and second output modes can be optimized according to the respective requirements of the input modalities or input devices. Maximum assistance for the user during operation can thus be ensured at any time for each input modality or for each input device.

According to one development, the user interface changes from the first output mode to the second output mode as soon as it detects that the user would like to change from the first input modality to the second input modality or from the first input device to the second input device or has already done so.

This development makes it possible to dynamically select the respective optimum output mode.

In one particular development, the user interface detects the change by virtue of the fact that the user has pressed a “push-to-talk” button or has spoken a keyword.

This development makes it possible for the user to change from manual input to voice input in a simple manner.

According to one embodiment, the first input modality allows manual input and the second input modality allows voice input.

In another embodiment, the first input modality allows manual input and the second input modality allows input by means of eye movements.

According to one development, the information is output on a screen in the form of pictograms in the first output mode and in the form of text in the second output mode.

This development affords the advantage that the screen can be kept as clear as possible and as detailed as necessary at any time. The information is optimized by virtue of the respective forms for the respective input modality. During manual input, the pictograms enable a clear visual representation which can be quickly comprehended. In contrast, during voice input, the pictograms are replaced with text which represents the keywords required by the voice input system. As a result, the screen has a high text load only when verbalization of the functions is also actually required. Input errors caused by terms which are not known to the voice recognition system and are synonymous with the voice commands may thus be distinctly minimized.

In one particular development, the pictograms displayed in the first output mode are displayed in reduced or altered form beside or under the text in the second output mode.

This affords the advantage that the pictograms can still be used as anchor points for the visual search by the user even during voice input.

According to one embodiment, the information is output to the user in a non-verbal form in the first output mode and in a verbally acoustic manner in the second output mode.

This means that manual selection of a function by the user can be confirmed, for instance, by means of a click, that is to say a non-verbal acoustic signal. The click provides sufficient information since the user generally receives visual feedback on which function he has just selected anyway during manual input.

In contrast, during voice input, the selection of a function by the user is confirmed by means of a verbal acoustic output. This is advantageous, for instance, when the driver of a vehicle activates a function of the on-board computer by means of a voice command and in the process keeps his eye on the roadway. He is provided with content-related feedback on the selected function by virtue of the verbal acoustic output. In both input modalities, it is thus ensured that the information output is kept as concise as possible and simultaneously as precise as necessary.

In one particular development, the information is output in the form of pictograms. In this case, the distances between the pictograms or the dimensions of the latter are greater in the second output mode than in the first output mode.

The development takes into account the fact that, in the case of manual input, for instance using a mouse or a graphics tablet, considerably smaller pictograms, that is to say icons, buttons etc., which are also at a short distance from one another can be selected by the user in a purposeful manner. In contrast, when eye tracking is used, a comparably accurate input by the user is not possible and so the distances between the pictograms or the dimensions of the latter must be selected to be appropriately greater. In this case, the fact that the resolution of the eye tracker decreases toward the edge of the screen can be taken into account so that the distance between the pictograms must increase toward the edge of the screen.

The user interface has means for carrying out the method. The vehicle cockpit has means for carrying out the method. The computer program carries out the method as soon as it is executed in a processor.

The invention is explained in more detail below using exemplary embodiments which are diagrammatically illustrated in the figures, in which, in detail:

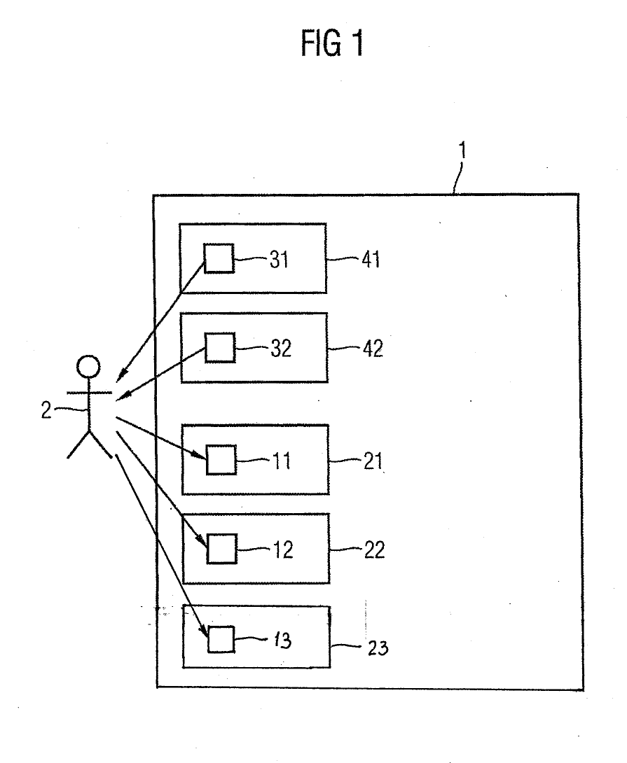

FIG. 1: shows a diagrammatic illustration of input and output,

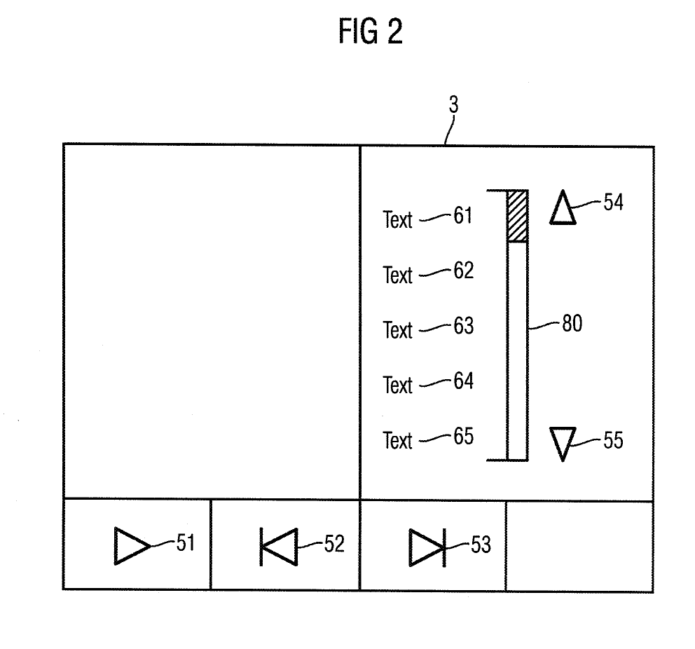

FIG. 2: shows a screen output in a first output mode, and

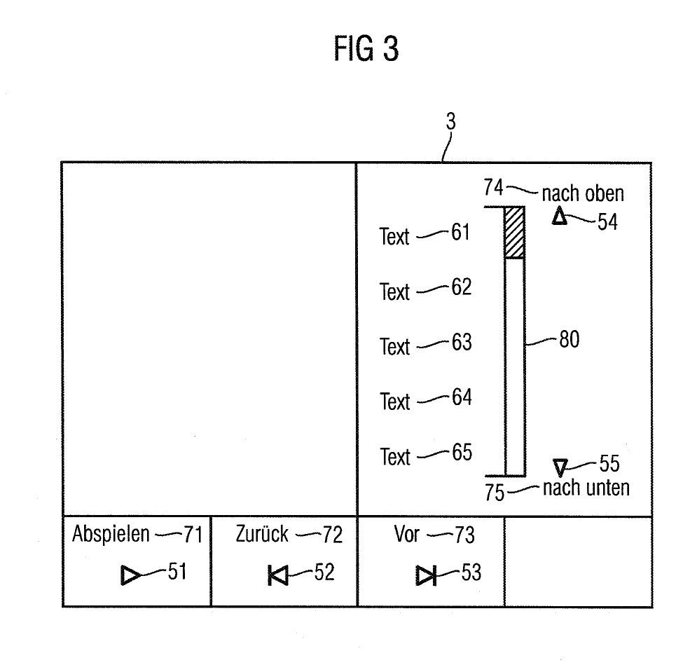

FIG. 3: shows a screen output in a second output mode.

FIG. 1 shows a diagrammatic illustration of input and output according to a first exemplary embodiment. A user 2 interacts with a user interface 1. Interaction is effected using a first input device 11 and a second input device 12. The first input device 11 may be, for example, a mouse and the second input device 12 may be a microphone which is used for voice input. Accordingly, the first input device 11 falls under a first input modality 21, manual input in this case, and the second input device 12 falls under a second input modality 22, voice input in this case. As already discussed in the introduction, any other desired input devices and input modalities are possible as an alternative or in addition. In particular, the first input device 11 and the second input device 12 may also belong to the same input modality and may nevertheless have such different characteristics that a dynamic change of the output mode as described below is advantageous.

The user 2 uses his inputs to select functions of a technical system to which the user interface 1 is connected. As mentioned initially, any desired technical systems, from the vehicle computer to the multimedia console, are conceivable in this case. In order to assist with the selection of the functions by the user 2, the user interface 1 outputs information to the latter, which information can represent the functions, can present the functions for selection or else can confirm their selection. The information may be in any desired form, for instance in the form of windows, menus, buttons, icons and pictograms in the context of graphical output using a screen or a projection display; it may also be output acoustically, in the form of non-verbal signals or in the form of verbal voice output. Thirdly, the information may also be transmitted haptically to the user's body. For example, as shown in FIG. 1, pictograms are output in a first output mode 41 as a first form 31 of the information, whereas voice is output in a second output mode 42 as a second form 32 of the information.

FIG. 2 and FIG. 3 respectively show a first output mode and a second output mode according to a second exemplary embodiment. A screen 3 on which the output information is displayed is illustrated in each case. In this case, the first output mode according to FIG. 2 is optimized for manual input. In this case, manual input may be enabled, for instance, by means of so-called “soft keys”, turn and press actuators, switches, a keyboard, a mouse, a graphics tablet or the like. According to FIG. 2, the information is displayed in the first output mode in a first form, by means of pictograms 51, 52, 53, 54, 55, as can be seen from the figure. In the context of manual input, the pictograms 51, 52, 53, 54, 55 allow an intuitive representation of the respective function, which can be easily found, for the user as a result of the respective symbol. For example, the pictogram 51 contains the known symbol for playing back a multimedia file. The pictograms 52 and 53 are known from the same context. Furthermore, titles of multimedia contents are represented by text 61, 62, 63, 64, 65. A scroll bar 80 makes it possible to scroll down the list indicated. The scroll bar 80 is controlled by selecting the pictograms 54 and 55. The aim of the first output mode shown in FIG. 2 is thus to avoid the screen 3 being overloaded with text and making it possible for the user to intuitively navigate through the functions of the respective technical system.

FIG. 3 shows a second output mode in the second exemplary embodiment. In this case, the second output mode is optimized for voice input. The user interface changes from the first to the second output mode, for instance, when the user would like to change from manual input to voice input or has already done so. The user interface detects this, for instance, by means of a spoken key word or the pressing of a “push-to-talk” button or the operation of another suitable device (for example using gesture, viewing and/or movement control). In the second output mode, the pictograms 51, 52, 53, 54, 55 are either entirely masked, reduced in size or grayed out or moved to the background in some other way. The second output mode outputs the information in a second form which explicitly verbalizes and displays the voice commands which can be recognized by the user interface as part of voice input. Specifically, these are the voice commands 71, 72, 73, 74, 75 which are assigned to the known functions of the respective pictograms 51, 52, 53, 54, 55. The text 61, 62, 63, 64, 65 is also shown in bold in FIG. 3, as a result of which the user interface signals to the user that the respective multimedia contents can be selected using the respective text as a voice command. Alternatively, text which represents voice commands can also be emphasized by changing the color or font size or by means of underlining and the like.

In a third exemplary embodiment, the user interface distinguishes between manual input and input by means of eye movements which are recorded by an eye tracker. In the case of input by means of eye movements, pictograms are displayed on an enlarged scale or else at greater distances since, on account of the lower resolution of the eye tracker, the user cannot interact with the user interface in as accurate a manner as with a manual input device.

In a fourth exemplary embodiment, the information is output acoustically rather than visually. In this case too, a distinction can again be made between manual input and voice input. In the case of manual input, a non-verbal acoustic signal in the form of a click, for instance, suffices to confirm a selection by the user, whereas, in the case of voice input, a verbal acoustic voice output is desirable in order to confirm the user's selection. This may be due to the fact, for instance, that the user makes the voice input in a vehicle and would like to keep his eye on the road. This is why he requires content-related feedback on which voice command has been recognized. In contrast, in the case of manual input, it can be assumed that the user has already visually perceived which function he has selected, with the result that a click suffices as the acoustic output.

Furthermore, it is possible for the user interface to output information visually in the first output mode, but to output information acoustically or haptically in the second output mode. This makes it possible to take into account the respective input modality or the respective input device by suitably selecting the output modality.

1.-12. (canceled)

13. A method for selecting functions with the aid of a user interface, comprising:
selecting, by a user, functions of a technical system using the user interface;
generating information that at least one of represents the functions and confirms selection of the functions by the user;
outputting, in a first output mode, the generated information in a first form which is optimized for one of a first input modality and a first input device; and
outputting, in a second output mode, the information in a second form which is optimized for one of a second input modality and a second input device.

14. The method as claimed in claim 13, further comprising:
changing the user interface from the first output mode to the second output mode when the user interface detects that the user seeks a change from one of the first input modality to the second input modality or the first input device to the second input device, or when the user interface detects that the user has already implemented the change.

15. The method as claimed in claim 14, further comprising:
detecting, at the user interface, the change based on whether the user has one of pressed a “push-to-talk” button and has spoken a keyword.

16. The method as claimed in claim 13, wherein the first input modality allows manual input and the second input modality allows voice input.

17. The method as claimed in claim 13, wherein the first input modality allows manual input and the second input modality allows input by eye movements.

18. The method as claimed in claim 16, further comprising outputting the information on a screen as pictograms in the first output mode and text in the second output mode.

19. The method as claimed in claim 18, further comprising displaying the pictograms displayed in the first output mode in one of reduced and altered form one of adjacent and under the text in the second output mode.

20. The method as claimed in claim 16, further comprising outputting the information to the user in one of a non-verbal form in the first output mode and a verbally acoustic manner in the second output mode.

21. The method as claimed in claim 17, further comprising:
outputting the information as pictograms;
wherein distances between one of the pictograms and dimensions of the pictograms are greater in the second output mode than in the first output mode.

22. A user interface for selecting functions, comprising:
a first input device;
a second input device; and
an output device configured to display, in a first output mode, generated information in a first form which is optimized for one of a first input modality and the first input device, and to display, in a second output mode, the information in a second form which is optimized for one of a second input modality and a second input device.

23. A vehicle cockpit having the user interface of claim 22.

24. A computer-readable medium encoded with a program executed by a processor of a computer that causes selection of functions with the aid of a user interface, comprising:
program code for receiving an indication of a user selection of functions of a technical system using the user interface;
program code for generating information that at least one of represents the functions and confirms selection of the functions by the user;
program code for outputting, in a first output mode of the user interface, the generated information in a first form which is optimized for one of a first input modality and a first input device; and
program code for outputting, in a second output mode of the user interface, the information in a second form which is optimized for one of a second input modality and a second input device.
